(19) United States
(12) Patent Application Publication
(10) Pub. No.: US 2019/0101869 A1
(43) Pub. Date: Apr. 4, 2019

(54) SEQUENTIAL DISPLAYING METHOD

(71) Applicant: E Ink Holdings Inc., Hsinchu (TW)

(72) Inventors: Huei-Chuan Lee, Hsinchu (TW); Hsin-Chung Wu, Hsinchu (TW); Sin-Hsien Yeh, Hsinchu (TW); Ling-Chiang Chu, Hsinchu (TW)

(73) Assignee: E Ink Holdings Inc., Hsinchu (TW)

(21) Appl. No.: 16/059,054

(22) Filed: Aug. 9, 2018

(30) Foreign Application Priority Data
Sep. 29, 2017 (CN) 201710905873.0

(51) Int. Cl. G04G 9/00; G04G 9/12; G04G 9/08; G09B 19/12

(52) U.S. Cl. CPC G04G 9/0094; G09B 19/12; G04G 9/087; G04G 9/124

(57) ABSTRACT

A sequential displaying method is provided. The method includes providing a display device which includes a first display area. The first display area has N first sub-areas that are arranged in sequence, wherein N is positive integer. Then, displayed images in the N first sub-areas are sequentially updated, wherein a time interval of updating the displayed images in two adjacent first sub-areas is 60/N seconds and a frequency for updating a displayed image in each of the first sub-areas is once every 60 seconds. Thus, a method for displaying time information could be improved.

### CROSS-REFERENCE TO RELATED APPLICATION

This application claims the priority benefit of China application serial no. 201710905873.0, filed on Sep. 29, 2017. The entirety of the above-mentioned patent application is hereby incorporated by reference herein and made a part of this specification.

### BACKGROUND OF THE INVENTION

### Field of the Invention

The invention relates to a displaying method, particularly a sequential displaying method.

### Description of Related Art

As technology advanced, all kinds of displaying techniques have been continuously researched on and commodified into display devices of all sizes, such as electro-phoretic displays (EPD), liquid crystal displays, etc. Display devices usually employ digital numbers or hands to display time information, such that users are able to quickly learn the current time. However, take electro-phoretic displays for example, the time required for updating images is relatively long and the electro-phoretic displays thus cannot be used to display image information at higher changing frequency. For example, images for displaying a second hand or the number information on second require changes per second. If electro-phoretic displays are employed to display such information, problems of poor readability due to persistence of vision would be raised.

### SUMMARY OF THE INVENTION

A sequential displaying method is provided in the invention, the sequential displaying method is a displaying method that is able to improve time displaying.

The sequential displaying method of the invention includes providing a display device. The display device includes a first display area. The first display area has N first sub-areas that are arranged in sequence. N is a positive integer. The sequential displaying method also includes sequentially updating displayed images in the N first sub-areas, wherein a time interval of updating the displayed images in two adjacent first sub-areas of the N first sub-areas is 60/N seconds and a frequency for updating the displayed image in each of the N first sub-areas is once every 60 seconds.

In an embodiment of the invention, N may be 60.

In an embodiment of the invention, the N first sub-areas may be sequentially arranged along a path shaped as an enclosed ring. The sequential displaying method may further include sequentially updating displayed images in the N first sub-areas in a clockwise direction.

In an embodiment of the invention, the display device may further include a second display area. The second display area has M second sub-areas. M is a factor of 60 or 60. The M second sub-areas may be sequentially arranged along another path shaped as an enclosed ring. The sequential displaying method may further include sequentially updating displayed images in the M second sub-areas in a clockwise direction, wherein a time interval of updating the displayed images in two adjacent second sub-areas of the M second sub-areas is 60/M minutes.

In an embodiment of the invention, the display device may further include a third display area. The third display has L third sub-areas. L is a factor of 12 or 12. The L third sub-areas may be sequentially arranged along another path shaped as an enclosed ring. The sequential displaying method may further include sequentially updating displayed images in the L third sub-areas in a clockwise direction, wherein a time interval of updating the displayed images in two adjacent third sub-areas of the L third sub-areas is 12/L hours.

In an embodiment of the invention, the first display area may be configured to display information on second.

In an embodiment of the invention, the display device may further include a second display area. The first display area is disposed in a neighboring area of the second display area. The sequential displaying method may further include displaying at least one of information on time, information on date, and information on day of a week in the second display area by the display device.

In an embodiment of the invention, the second display area displays an hour-hand image and a minute-hand image. The sequential displaying method may further include using the hour-hand image and the minute-hand image to display information on time.

In an embodiment of the invention, the display device may further include an hour hand and a minute hand. The hour hand and the minute hand are configured to display information on hour and minute. The first display area is configured to display information on second.

In an embodiment of the invention, the display device may include an electro-phoretic display.

In an embodiment of the invention, a method of updating a displayed image in each of the N first sub-areas includes changing a first image to a second image. One of the first image and the second image is a black image, and the other of the first image and the second image is a white image.

Based on the above, in the sequential displaying method provided in the embodiments of the invention, the display device includes a first display area having N first sub-areas that are arranged in sequence and sequentially updating displayed images in the N first sub-areas with the following method: a time interval of updating the displayed images in two adjacent first sub-areas of the N first sub-areas is 60/N seconds and a frequency for updating the displayed image in each of the N first sub-areas is once every 60 seconds, such that a problem of poor readability when displaying the information on second may be solved.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of the specification. The drawings illustrate exemplary embodiments of the invention and, together with the description, serve to explain the principles of the invention.

FIG. 1 is a schematic top view of a display device employing the sequential displaying method of the invention.

FIG. 2 is a schematic top view of another display device employing the sequential displaying method of the invention.

FIG. 3 is a schematic top view of yet another display device employing the sequential displaying method of the invention.

FIG. 4A to FIG. 4C are schematics top view of still another display device employing the sequential displaying method of the invention.

### DESCRIPTION OF THE EMBODIMENTS

Exemplary embodiments of the invention are explicitly provided below and explanations thereon are provided in drawings. Whenever it is applicable, identical or similar reference numbers are used to represent identical or similar components in drawings and descriptions and embodiments may be combined with one another. Identical or similar concepts or process are not repeated in some embodiments.

In the specification, ordinal numbers such as first, second, etc. are used to describe all kinds of areas or images, so as to distinguish one area or image from another.

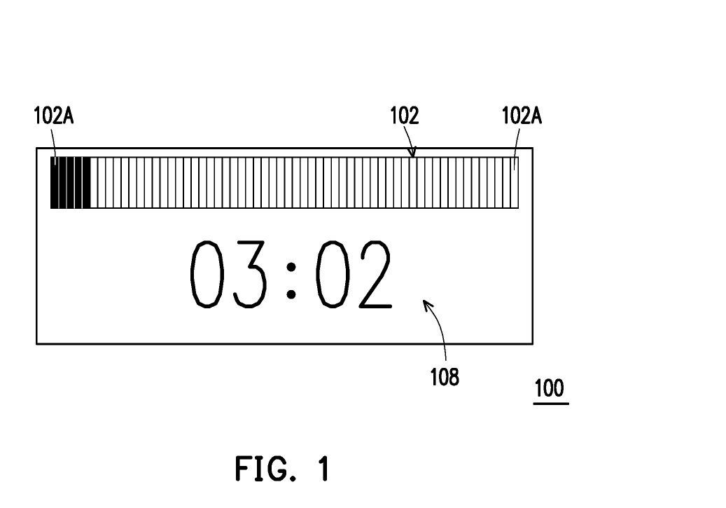

FIG. 1 is a schematic top view of a display device employing the sequential displaying method of the invention. Referring to FIG. 1, the sequential displaying method of the invention includes providing a display device 100. The display device 100 may be an electro-phoretic display, a liquid crystal display, or other proper displays. An electro-phoretic display is taken as an example in the embodiment. The display device 100 includes a first display area 102. The first display area 102 has N first sub-areas 102A that are arranged in sequence. N is a positive integer. More specifically, the N first sub-areas 102A are arranged along a linear path and each of the N first sub-areas 102A is arranged in front of or behind an adjacent first sub-area 102A of the N first sub-areas 102A. In the embodiment, displayed images in the N first sub-areas 102A may be sequentially updated to display required information. For example, a method of updating a displayed image in each of the N first sub-areas 102A may include changing a first image to a second image, wherein a color of the first image differs from a color of the second image. For example, one of the first image and the second image may be a black image, and the other of the first image and the second image may be a white image. Nevertheless, the invention is not limited thereto. In other embodiments, colors of the first image and the second image are not limited as long as a difference therebetween is sufficient for users to identify.

In the embodiment, a frequency for updating a displayed image in each of the N first sub-areas 102A is once every 60 seconds and a time interval of updating displayed images in two adjacent first sub-areas of the N first sub-areas is 60/N seconds. N is a positive integer. When N is 60, the first display area 102 may be used to display information on second. At this time, a time interval of updating displayed images in two adjacent first sub-areas 102A of the N first sub-areas 102A is 1 second but is not limited thereto. N may also be another proper number based on actual needs. A time interval of updating the displayed images in two adjacent first sub-areas 102A of the N first sub-areas 102A is shorter than 60/N seconds. Users may recognize, evaluate or calculate time with use of the display device 100. For example, when users observe displayed images in five consecutive first sub-areas 102A of the N first sub-areas 102A being sequentially updated, 5*(60/N) seconds have passed. In addition, users may also use an image of the first display area 102 to determine the current time.

Specifically, when the first display area 102 is divided into 60 first sub-areas 102A, N may be defined as 60 and a first sub-area 102A of the 60 first sub-areas 102A on the left-most side to a first sub-area 102A of the 60 first sub-areas 102A on the right-most side may sequentially represent the first second to the sixtieth second. After a displayed image in a first first sub-area 102A on the left-most side is updated from a first image to a second image in the first second, the first first sub-area 102A continues to display the second image for 60 seconds. In the second second (one second after the first first sub-area 102A is updated), a displayed image in a second first sub-area 102A is updated from a first image to a second image and the second first sub-area 102A continues to display the second image for 60 seconds. Displayed images in rest of the first sub-areas 102A are updated in the same manner. Hence, in the sixtieth second, the displayed images in sixty first sub-areas 102A have all been updated from the first image to the second image. Users are able to determine the current second by observing an ordinal number of the first sub-area 102A displaying the second image.

Then, in the sixty-first second, a displayed image in the first first sub-area 102A is updated from a second image to a first image and the first image is continuously displayed for 60 seconds. In the sixty-second second (i.e. one second after the first first sub-area 102A is updated), a displayed image in the second first sub-area 102A is updated from a second image to a first image and the first image is continuously displayed for 60 seconds. Displayed images in rest of the first sub-areas 102A are all updated in the same manner. In this way, the displayed image in each of the first sub-areas 102A is updated every 60 seconds. Users are able to determine the current second by observing an ordinal number of the first sub-area 102A displaying the first image. With such displaying method, a displayed image in each of the first sub-areas 102A of the display device 100 does not need to be updated every second and information on second may still be presented for users to correctly determine the current time (second). Moreover, users are able to sense the lapse of time (e.g. seconds) through the plurality of first sub-areas 102A sequentially being updated.

In addition, the display device 100 may further include other display areas, such as a second display area 108. The first display area 102 is disposed in a neighboring area of the second display area 108. More detailed, the first display area 102 may be disposed on at least one side of the second display area 108. In the embodiment, the first display area 102 is, for example, disposed on an upper side of the second display area 108. A displaying method of the display device 100 may further include displaying at least one of information on time, information on date, and information on day of a week in the second display area 108. Taking FIG. 1 as an example, the second display area 108 may display information on time. Hence, users are able to determine the current hour and minute according to an image of the second display area 108 and determine the current second according to an image of the first display area 102. As a result, the display device 100 is able to clearly display information on hour, minute, and second. Since a frequency for updating an image in each of the first sub-areas 102A configured to display second is once every 60 seconds, the information on second is unlikely to have a poor readability due to the limited updating speed of electro-phoretic display medium even if the display device 100 is an electro-phoretic display.

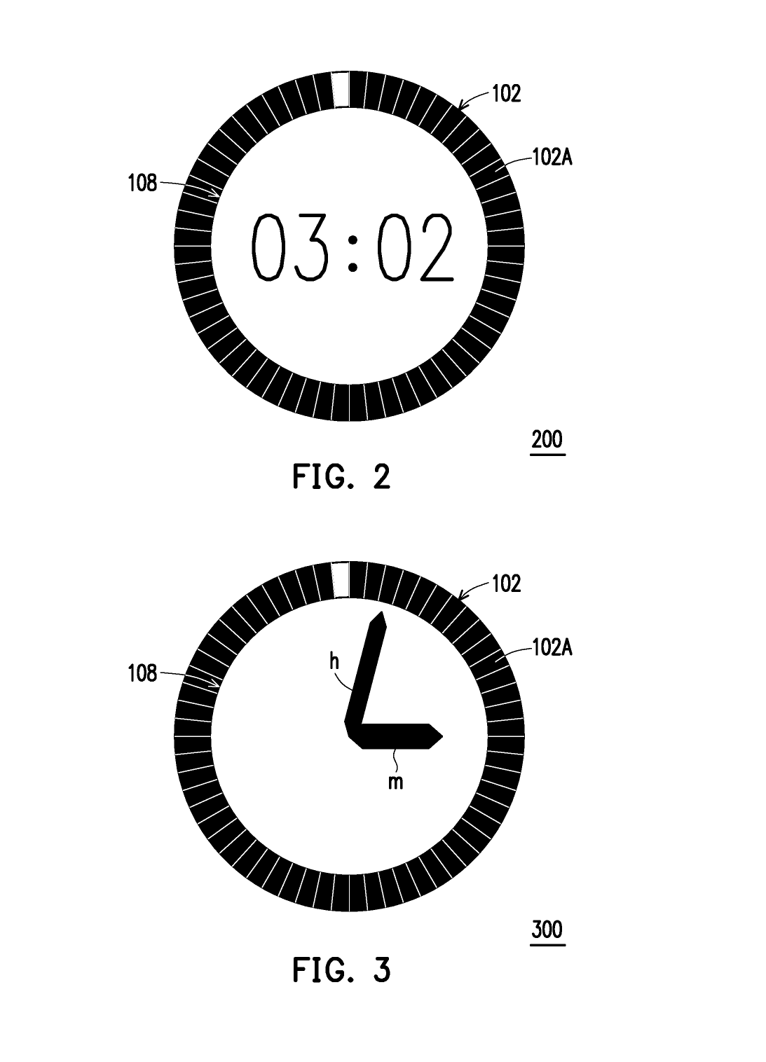

FIG. 2 is a schematic top view of another display device employing the sequential displaying method of the invention. Referring to FIG. 2, a display device 200 is a form of another display device employing the sequential displaying method of the invention. The display device 200 may be an alternative embodiment of the display device 100. N first sub-areas 102A in a first display area 102 of the display device 200 may be sequentially arranged along a path shaped as an enclosed ring. A shape of the path shaped as an enclosed ring is, for example, a circle but is not limited thereto. A shape of the path shaped as an enclosed ring may also be other proper shapes. In addition, a sequential displaying method of the display device 200 and the sequential displaying method of the display device 100 are substantially the same. Please refer to the sequential displaying method of the display device 100 for more detailed description unless additional description is given. The sequential displaying method in the embodiment may include sequentially updating displayed images in the N first sub-areas 102A in a clockwise direction but is not limited thereto. In some embodiments, the sequential displaying method may include sequentially updating displayed images in the N first sub-areas 102A in a counter-clockwise direction. In the display device 200, a second display area 108 may be disposed on an inner side of the first display area 102 shaped as an enclosed ring. The first display area 102 and the second display area 108 do not overlap with each other. In other words, the second display area 108 may be enclosed in or surrounded by the first display area 102.

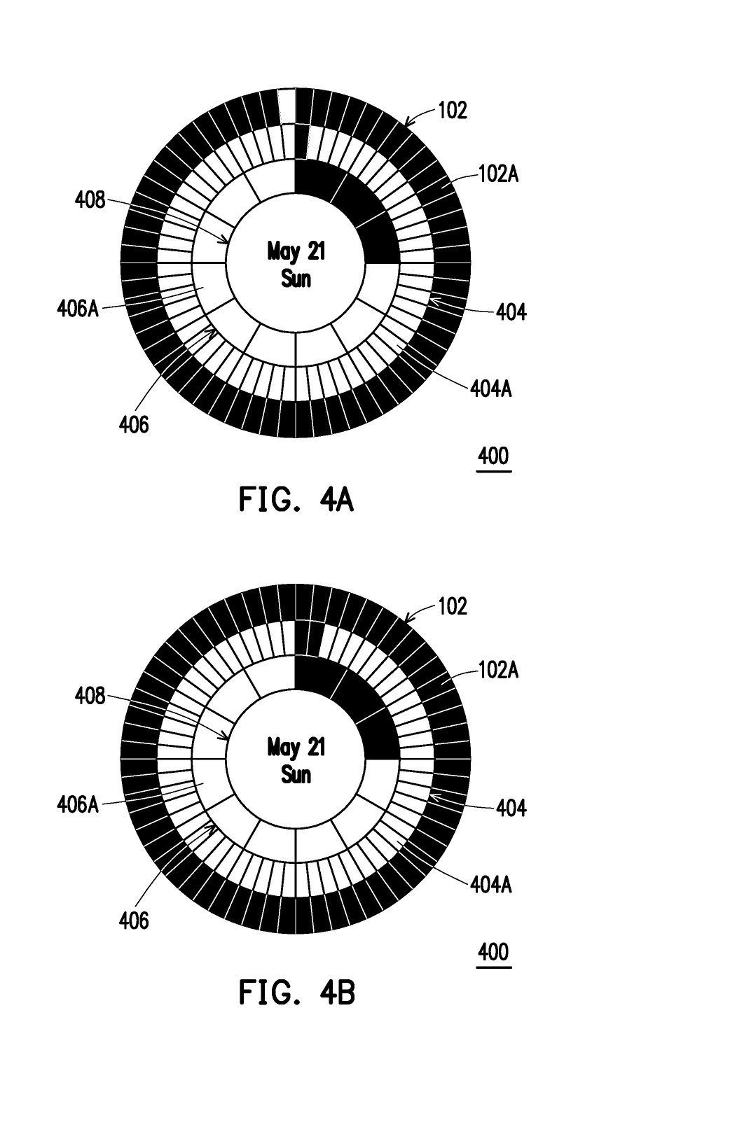

FIG. 3 is a schematic top view of yet another display device employing the sequential displaying method of the invention. Referring to FIG. 3, a display device 300 is another form of the display device applying the sequential displaying method of the invention. A basic structure of the display device 300 and the basic structure of the display device 200 are substantially the same. A difference therebetween lies in: a second display area 108 of the display device 300 is able to display an hour-hand image m and a minute-hand image h. The sequential displaying method may further include displaying information on time with the hour-hand image m and the minute-hand image h. Nevertheless, the invention is not limited thereto. In some embodiments, the display device 300 may further include a real hour hand (not illustrated here) and a real minute hand (not illustrated here) to display information on time by using the real hour hand (not illustrated here) and the real minute hand (not illustrated here) and display information on second in the first display area 102. In other words, information on time may be represented by the virtual hour-hand image m and the virtual minute-hand image h or by a real hour hand and a real minute hand.

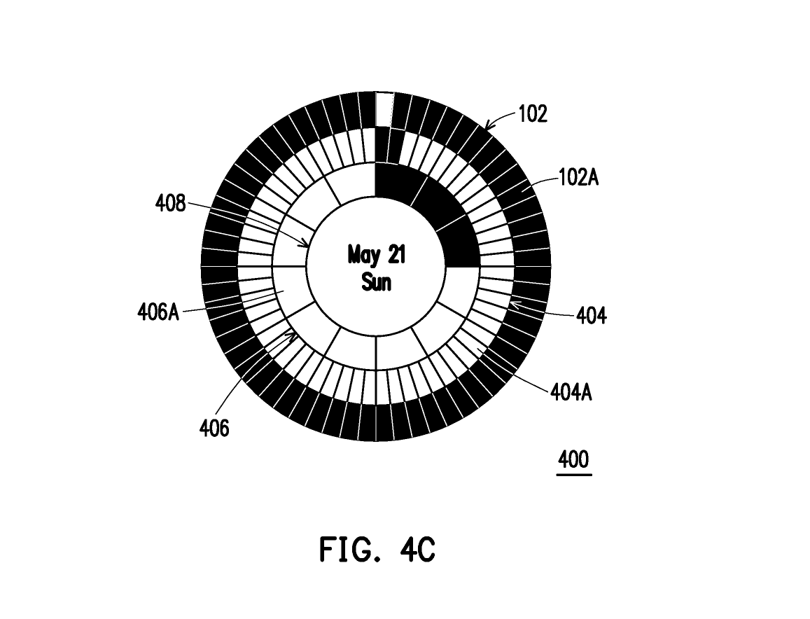

FIG. 4A to FIG. 4C are schematics top view of still another display device employing the sequential displaying method of the invention. Referring to FIG. 4A to FIG. 4C altogether, a display device 400 is yet another form of a display device employing the sequential displaying method of the invention. A structure of the display device 400 and the structure of the display device 200 are substantially the same. Please refer to the sequential displaying method of the display device 200 for more detailed description unless additional description is given. Comparing with the display device 200, the display device 400 may further include a second display area 404, a third display area 406, and a fourth display area 408.

The second display area 404 may be disposed on an inner side of the first display area 102 shaped as an enclosed ring. A center of the path shaped as a ring of the first display area 102 overlaps with a center of the path shaped as a ring of the second display area 404, but the first display area 102 and the second display area 404 do not overlap with each other. The second display area 404 has M second sub-areas 404A. M is a factor of 60 or 60. The M second sub-areas 404A may be arranged along another path shaped as an enclosed ring. A shape of the path shaped as an enclosed ring is, for example, a circle but is not limited thereto. A shape of the path shaped as an enclosed ring may also be other shapes. In the embodiment, the sequential displaying method may further include sequentially updating displayed images in the M second sub-areas 404A in a clockwise direction.

A method of updating the displayed image in each of the M second sub-areas 404A and a method of updating the displayed image in each of the N first sub-areas 102A are substantially the same. A major difference therebetween lies in: in the method of updating the displayed image in each of the M second sub-areas 404A, a time interval of updating displayed images in two adjacent second sub-areas 404A of the M second sub-areas is 60/M minutes. For example, the second display area 404 may be configured to display information on minute. As a result, M may be defined as 60, such that a time interval of updating displayed images in two adjacent second sub-areas 404A of the M second sub-areas 404A is one minute but is not limited thereto. M may also be other proper number based on actual needs.

When M is defined as 60 and a chosen second sub-area 404A of the M second sub-areas 404A serves as a starting point, the sequential displaying method may include updating a displayed image in a first second sub-area 404A of the M second sub-areas 404A from a first image to a second image in the first minute. In the second minute (i.e. one minute after the first second sub-area 404A is updated), a displayed image in a second second sub-area 404A of the M second sub-areas 404A is updated from a first image to a second image. Displayed images in rest of the second sub-areas 404A are updated in the same manner. Users are able to learn information on minute through the second sub-areas 404A being sequentially updated. Such displaying method differs from displaying time (e.g. minute) with digital numbers or a hand and offers another representation of time.

In addition, in the embodiment, the third display area 406 has L third sub-areas 406A. L is a factor of 12 or 12. The L third sub-areas 406A may be sequentially arranged along yet another path shaped as an enclosed ring. A shape of the path shaped as an enclosed ring is, for example, a circle but is not limited thereto. A shape of the path shaped as an enclosed ring may also be other shapes. The third display area 406 may be disposed on an inner side of the second display area 404 shaped as an enclosed ring. A center of the path shaped as a ring of the second display area 404 overlaps with a center of the path shaped as a ring of the third display area 406, but the first display area 102, the second display area 404, and the third display area 406 do not overlap with one another. In the embodiment, the second display area 404 is disposed between the first display area 102 and the third display area 406 but is not limited thereto. In other embodiments, the third display area 406 may be disposed in other locations.

The sequential displaying method of the fourth display device 400 may further include sequentially updating displayed images in the L third sub-areas 406A in a clockwise direction. A method of updating the displayed image in each of the L third sub-areas 406A and a method of updating the displayed image in each of the N first sub-areas 102A are substantially the same. A major difference therebetween lies in: in the method of updating the displayed image in each of the L third sub-areas 406A, a time interval of updating displayed images in two adjacent third sub-areas 406A of the L third sub-areas is 12/L hour. For example, the third display area 406 may be used to display information on hour. L may be defined as 12, such that a time interval of updating displayed images in two adjacent third sub-areas 406A of the L third sub-areas 406A is one hour but is not limited thereto. L may be other numbers based on actual needs.

When L is defined as 12 and a chosen third sub-area 406A of the L third sub-areas 406A serves as a starting point, the sequential displaying method may include updating a displayed image in a first third sub-area 406A of the L third sub-areas 406A from a first image to a second image in the first hour. In the second hour (one hour after the first third sub-area 406A is updated), a displayed image in a second third sub-area 406A of the L third sub-areas 406A is updated from a first image to a second image. Displayed images in rest of the L third sub-areas 406A are updated in the same manner. Users are able to learn the information on hour through the L third sub-areas 406A being sequentially updated. Such displaying method differs from displaying time (e.g. hour) with digital numbers or a hand and offers another representation of time. In addition, the fourth display area 408 of the display device 400 may be disposed on an inner side or an outer side of the third display area 406 shaped as an enclosed ring. The first display area 102, the second display area 404, the third display area 406, and the fourth display area 408 do not overlap with one another.

The display device 400 of FIG. 4A to FIG. 4C provides an example on employing the sequential displaying method of the invention to display time information. More specifically, the first display area 102 is used to display information on second, the second display area 404 is used to display information on minute, the third display area 406 is used to display information on hour, and the fourth display area 408 is used to display information on date and week. The first display area 102 has 60 first sub-areas 102A that are arranged in sequence, the second display area 404 has 60 second sub-areas 404A, and the third display area 406 has 12 third sub-areas 406A. Hence, time information displayed by the display device 400 of FIG. 4A is May 21^{st}, Sunday, and 3 o'clock 01 minute and 59 second. Time information displayed by the display device 400 of FIG. 4B is May 21^{st}, Sunday, and 3 o'clock 02 minute and 00 second. Time information displayed by the display device 400 of FIG. 4C is May 21^{st}, Sunday, and 3 o'clock 02 minute 01 second.

In conclusion of the above, the display device provided in the sequential displaying method of the invention includes the first display area having N first sub-areas that are arranged in sequence and sequentially updating displayed images in the N first sub-areas with the following method: a time interval of updating displayed images in two adjacent first sub-areas of the N first sub-areas is 60/N and a frequency for updating each of the first sub-areas of the N first sub-areas is once every 60 seconds. As a result, problems of poor readability due to persistence of vision in prior art may be avoided when applying the sequential displaying method of the invention in electro-phoretic displays to display information on second.

It will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

What is claimed is:

1. A sequential displaying method comprising:
providing a display device comprising a first display area, the first display area having N first sub-areas that are arranged in sequence, wherein N is a positive integer; and
sequentially updating displayed images in the N first sub-areas, wherein a time interval of updating the displayed images in two adjacent first sub-areas of the N first sub-areas is 60/N seconds and a frequency for updating the displayed image in each of the N first sub-areas is once every 60 seconds.

2. The sequential updating method of claim 1, wherein N is 60.

3. The sequential updating method of claim 1, wherein the N first sub-areas are sequentially arranged along a path shaped as an enclosed ring, the sequential displaying method further comprises sequentially updating the displayed images in the N first sub-areas in a clockwise direction.

4. The sequential updating method of claim 3, wherein the display device further comprises a second display area, the second display area has M second sub-areas, M is a factor of 60 or 60, the M second sub-areas are sequentially arranged along another path shaped as an enclosed ring, the sequential displaying method further comprises sequentially updating displayed images in the M second sub-areas in a clockwise direction, wherein a time interval of updating the displayed images in two adjacent second sub-areas of the M second sub-areas is 60/M minutes.

5. The sequential displaying method of claim 3, wherein the display device further comprises a third display area, the third display has L third sub-areas, L is a factor of 12 or 12, the L third sub-areas are sequentially arranged along another path shaped as an enclosed ring, the sequential displaying method further comprises sequentially updating displayed images in the L third sub-areas in a clockwise direction, wherein a time interval of updating the displayed images in two adjacent third sub-areas of the L third sub-areas is 12/L hours.

6. The sequential displaying method of claim 1, wherein the first display area is configured to display information on second.

7. The sequential displaying method of claim 1, wherein the display device further comprises a second display area, the first display area is disposed in a neighboring area of the second display area, the sequential displaying method further comprises displaying at least one of information on time, information on date, and information on day of a week in the second display area by the display device.

8. The sequential displaying method of claim 7, wherein the second display area displays an hour-hand image and a minute-hand image, the sequential displaying method further comprises using the hour-hand image and the minute-hand image to display information on time.

9. The sequential displaying method of claim 1, wherein the display device further comprises an hour hand and a minute hand displaying information on hour and minute and the first display area is configured to display information on second.

10. The sequential displaying method of claim 1, wherein the display device comprises an electro-phoretic display.

11. The sequential displaying method of claim 1, wherein a method of updating a displayed image in each of the N first N sub-areas comprises changing a first image to a second image, one of the first image and the second image is a black image, and the other of the first image and the second image is a white image.
